(19) United States
(12) Patent Application Publication
(10) Pub. No.: US 2026/0144235 A1
(43) Pub. Date: May 28, 2026

(54) PET TRAINING APPARATUS

(71) Applicant: Douglas Gregory Vogel, Portland, OR (US)

(72) Inventor: Douglas Gregory Vogel, Portland, OR (US)

(21) Appl. No.: 19/397,904

(22) Filed: Nov. 22, 2025

Related U.S. Application Data
(60) Provisional application No. 63/724,886, filed on Nov. 25, 2024.
(60) Provisional application No. 63/837,810, filed on Jul. 2, 2025.

(51) Int. Cl. A01K 27/00

(52) U.S. Cl. CPC A01K 27/005; A01K 27/009

(57) ABSTRACT

A dog training device that operates by using a cord or chain, e.g., a leash, to activate an internal spring-loaded mechanism that moves a contact, which opens or closes an electrical circuit. When the dog pulls onto the leash, the circuit closes and a signal, such as, e.g., a sound, is turned on to discourage the pulling. Releasing the leash permits the spring to return the contact to its original position, breaking the circuit and turning off the signal. In some cases, the sound is only audible to dogs and not humans. The device may be used to teach the dog to heel without inflicting harm.

### CLAIMS OF PRIORITY

This patent application claims priority from:
(1) U.S. provisional patent application No. 63/724,886, entitled ‘Pet training apparatus’, filed Nov. 25, 2024.
(2) U.S. provisional patent application No. 63/837,810, entitled ‘Pet training apparatus’, filed Jul. 2, 2025.

All applications are incorporated by reference herein in their entirety.

### FIELD OF TECHNOLOGY

This disclosure relates generally to a pet training apparatus.

### BACKGROUND

Dog training devices have evolved significantly over time to address various behavioral modification needs and training objectives. These devices generally fall into several main categories, each serving specific purposes in canine education and control. Traditional training devices include basic equipment such as leashes, collars, and harnesses.

Standard flat collars remain the most common type, providing a simple means of identification and control. Martingale collars, designed to prevent dogs from slipping out while walking, offer a gentler alternative to choke chains. Positive reinforcement tools represent another category, encompassing clickers, treat pouches, and target sticks. These devices support reward-based training methods, which have gained prominence in modern dog training approaches. Clicker training, in particular, has demonstrated effectiveness in marking desired behaviors precisely. Containment systems, both physical and electronic, form another notable category. These include traditional fencing, wireless boundaries, and underground fence systems designed to keep dogs within designated areas while allowing freedom of movement.

Despite technological advances, debate continues regarding the most effective and humane approaches to dog training, driving ongoing innovation in device design and methodology.

### BRIEF DESCRIPTION OF THE DRAWINGS

Figures are illustrated by way of example and are not limited to the accompanying drawings, in which, like references indicate similar elements.

FIG. 1A is an illustration of a double-cylinder dog training device in a resting position. FIG. 1B is an illustration of the double-cylinder dog training device in an extended position.

FIG. 2 is a schematic diagram of the inner cylinder of the double-cylinder dog training device.

FIG. 3A is a schematic diagram of the outer cylinder of the double-cylinder dog training device. FIG. 3B is a schematic diagram of an alternative configuration of the outer cylinder of the double-cylinder dog training device.

FIG. 4 is a diagram of an operation of a dog training device.

FIG. 5A is an electrical circuit schematic for the double-cylinder dog training device. FIG. 5B is a block diagram showing the component parts of the dog training device.

FIG. 6 is a schematic diagram of the electrical wiring of the double-cylinder dog training device.

FIG. 7 shows an alternative configuration of the double-cylinder dog training device.

FIG. 8A is a schematic diagram of the inner cylinder of the alternative configuration of FIG. 7. FIG. 8B is a schematic diagram of the outer cylinder of the alternative configuration of FIG. 7.

FIG. 9 illustrates a single-cylinder configuration for a dog training device.

### DETAILED DESCRIPTION

Although the present has been described with reference to specific examples, it will be evident that various modifications and changes may be made without departing from their spirit and scope. The modifications and variations include any relevant combination of the disclosed features. Equivalent elements, materials, processes or steps may be substituted for those representatively illustrated and described herein. Certain structures and features may be utilized independently of the use of other structures and features. In addition, the components shown in the figures, their connections, couplings, relationships, and their functions, are meant to be exemplary only, and are not meant to limit the examples described herein.

A dog training device that operates by using a cord or chain, e.g., a leash, to activate an internal spring-loaded mechanism that moves a contact, which opens or closes an electrical circuit. When the dog pulls on the leash, the circuit closes and a signal, such as, e.g., a sound, is turned on to discourage the pulling. Releasing the leash permits the spring to return the contact to its original position, breaking the circuit and turning off the signal. In some cases, the sound is only audible to dogs and not humans. The device may be used to teach the dog to heel without inflicting harm.

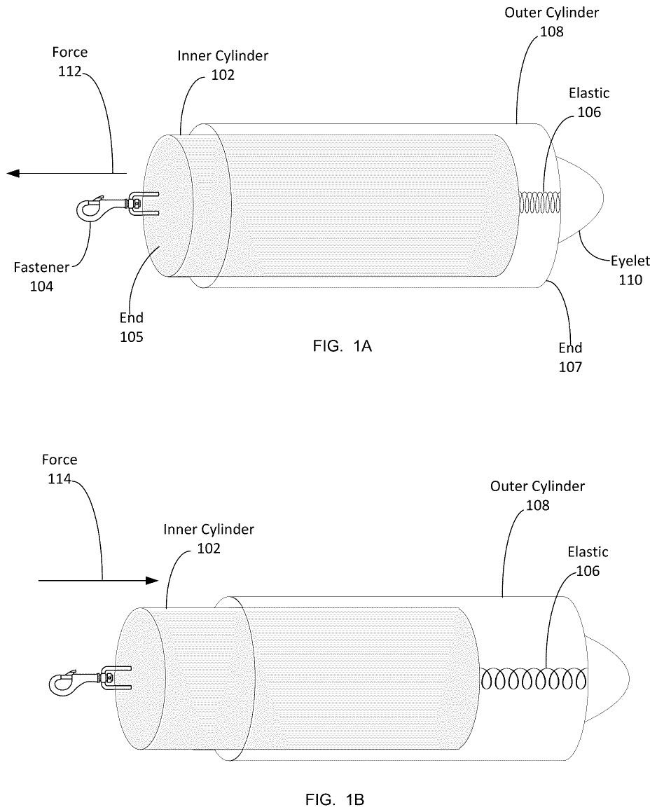

FIG. 1A is an illustration of a double-cylinder dog training device in a resting position. The device may comprise an inner cylinder 102 attached to a fastener 104, such as, e.g., a snap hook, on an external end 105, and an elastic 106 attached to the opposing external end. In some cases, elastic 106 may span the length of inner cylinder 102 such that inner cylinder 102 is open on the end opposite of end 105, and is physically coupled to inner cylinder 102 on the opposite face of end 105. Elastic 106 may be any device or material that is able to automatically return to a resting position after being deformed through the application of a force, such as, e.g., a stainless steel spring or a rubber bungee. An outer cylinder 108 may partially encompass the inner cylinder 102, and may include eye 110. For example, inner cylinder 102 may be situated within outer cylinder 108 more than half of inner cylinder 102's length, such, as, e.g., 80-90%. When force 112 is exerted, such as, e.g., by pulling from a dog, elastic _06 may expand and elongate from a resting state to a deformed state, permitting inner cylinder 102 to move farther out from outer cylinder 108. An audible sound may emit from the device through a speaker (not shown), such that to stop the dog from pulling. In some cases, the sound may only be audible to the dog and not a human. Fastener 104 may be configured to hook or latch onto the dog's collar or harness, and eyelet 110 may permit a leash to attach thereto. Eyelet 110 may be any protrusion from end 107 of cylinder 108 with a central opening that can accommodate a hook or latch of the leash.

FIG. 1B is an illustration of the double-cylinder dog training device in an extended position. As discussed in FIG. 1A, a sound may emit from the speaker of the device when the dog pulls on device, which is disposed between the dog's collar or harness and the leash. The sound may be unpleasant to the dog, which causes it to stop pulling on the device. Elastic 106 may contract and shorten from the elongated state to the resting state while exerting force 114, causing inner cylinder 102 to move farther within outer cylinder 108. Force 114 and force 112 may be opposing in direction, such as, e.g., 180-degrees apart. Inner cylinder 102 and outer cylinder 108 may be made from a durable material, such as, e.g., polycarbonate or glass-filled nylon, and may be separated circumferentially by a micro-thin gasket made of, e.g., Teflon, hemp or a synthetic material, thus permitting inner cylinder 102 and outer cylinder 108 to slide while limiting dust and moisture from entering outer cylinder 108.

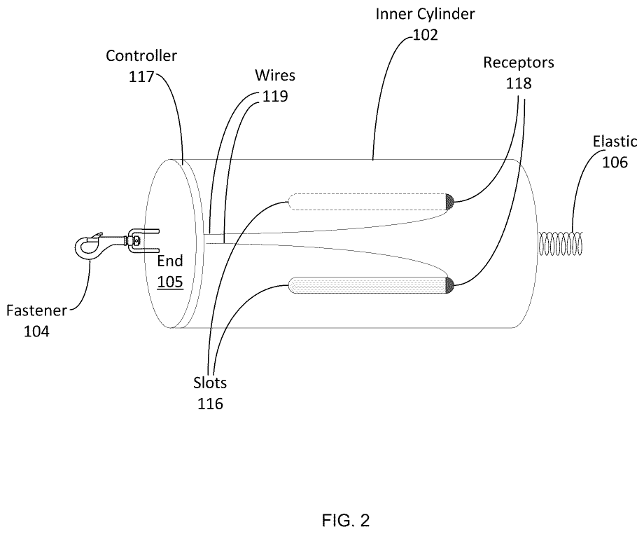

FIG. 2 is a schematic diagram of the inner cylinder of the double-cylinder dog training device. Inner cylinder 102 may comprise two slots 116 running lengthwise, set 180-degrees apart, and disposed at approximately a middle portion of inner cylinder 102. The end farthest from fastener 104 of each slot may comprise conductive receptors 118, which may be connected by wires 119 to outer cylinder 108. Both wires 119 may be connected to an electronic controller 117 disposed within a space of end 105 that includes fastener 104. Slots 116 may fully perforate inner cylinder 102.

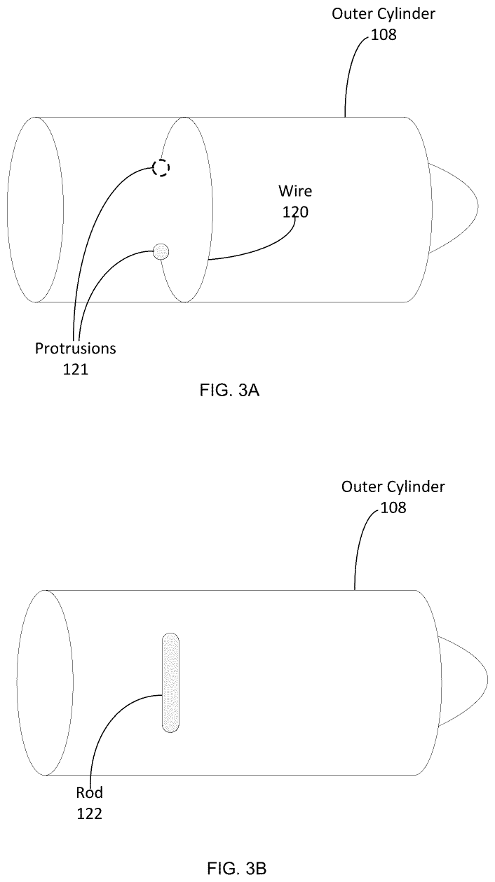

FIG. 3A is a schematic diagram of the outer cylinder of the double-cylinder dog training device. Outer cylinder 108 may comprise two conductive protrusions 121 on the inner wall, set 180-degrees apart, and correspond with slots 116 of inner cylinder 102. Protrusions 121 may serve as a guide, and limit stop, permitting inner cylinder 102 and outer cylinder 108 to slide lengthwise without rotating, or opening and closing too far. Protrusions 121 may be connected by conductive wire 120 within the inner wall of outer cylinder 108. For example, when inner cylinder 102 and outer cylinder 108 are fully extended, such as, e.g., by the dog's pull, protrusions 121 may mate with receptors 118, thus completing the circuit with inner cylinder 102. Receptors 118 may be of any configuration that accommodates protrusions 121, such as, e.g., semi-circular or half-donut shaped.

FIG. 3B is a schematic diagram of an alternative configuration of the outer cylinder of the double-cylinder dog training device. Outer cylinder 108 may comprise a single rod 122 that spans its diameter and anchored to the inner wall of outer cylinder 108, such that a cross-section of outer cylinder 108 is divided into two equal semi-circular halves. In some cases, rod 122 may run along the inner perimeter of outer cylinder 108. Rod 122 may serve as a guide, and limit stop, permitting inner cylinder 102 and outer cylinder 108 to slide lengthwise without rotating, or opening and closing too far. For example, when inner cylinder 102 and outer cylinder 108 are fully extended, such as, e.g., by the dog's pull, the ends of rod 122 may mate with receptors 118, thus completing the circuit with inner cylinder 102. Receptors 118 may be reinforced, such as, e.g., comprising enhanced wall thickness, and may be of any configuration that accommodates the ends of rod 122, such as, e.g., semi-circular or half-donut shaped.

Protrusions 121 and rod 122 may be interchangeable. For example, if elastic 106 stretches the entire length of outer cylinder 108, the protrusions 121 may be used, while rod 122 may be used if elastic 106 is shorter than the length of outer cylinder 108.

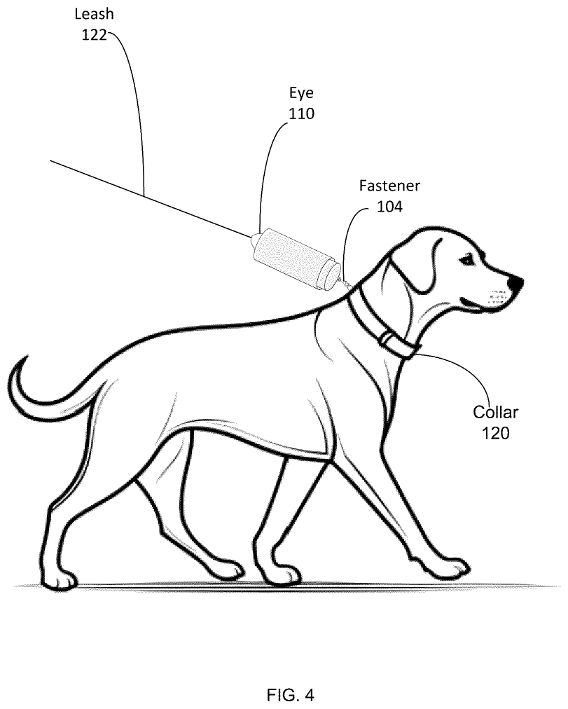

FIG. 4 is a diagram of an operation of a dog training device. The device may be connected to a dog harness or collar 120 through fastener 104. Fastener 104 may be any device that hooks or latches onto collar 120, such as, e.g., a snap hook. A human operator (not shown), such as, e.g., the dog's owner, may grasp leash 122, which is connected to the device through a hook or latch that fastens to eye 110. The device may be configured to produce a signal, such as, e.g., an audible sound, when the dog pulls away from the human operator with a predetermined amount of force. The signal may cause the dog to stop pulling, which deactivates the signal. The device may be used to teach the dog to heel without inflicting harm.

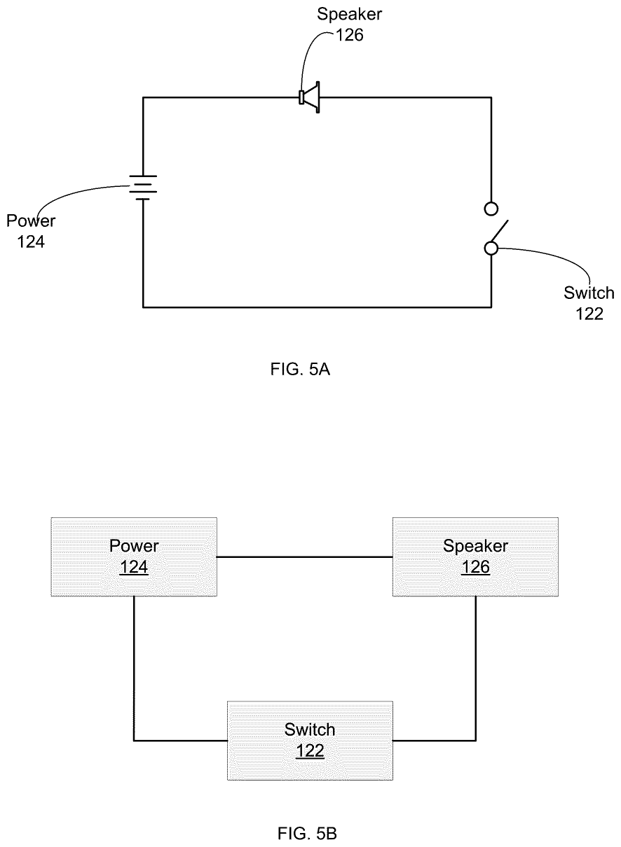

FIG. 5A is an electrical circuit schematic for the double-cylinder dog training device. FIG. 5B is a block diagram showing the component parts of the dog training device. Switch 122 may be in an open position when the dog training device is at a resting position. When a dog pulls on the leash that is connected to the device, conductive protrusions of the outer cylinder physically contact receptors of the inner cylinder, the circuit is then completed and switch 122 changes to a closed position. This causes current to flow through the circuit from power 124 to speaker 126, which produces a sound. Power 124 may be of any source, such as, e.g., a lithium-ion battery. Speaker 126 may be communicatively coupled to controller 117 comprising a processor and a memory. The memory may store the recorded sound.

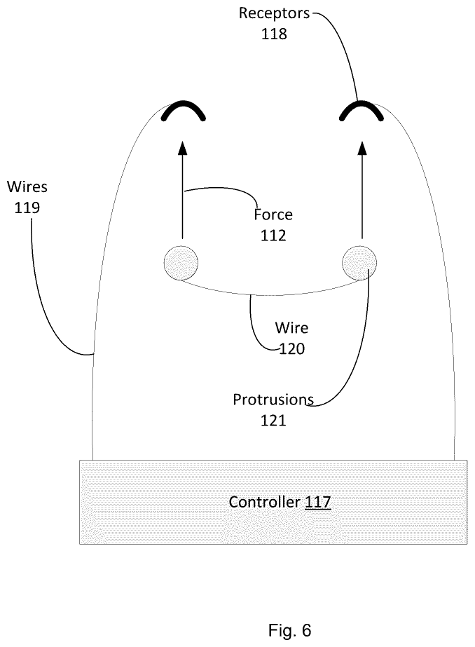

FIG. 6 is a schematic diagram of the electrical wiring of the double-cylinder dog training device. Receptors 118 may be disposed on the inner cylinder, and may be independently connected to electronic controller 117 through wires 119. In some cases, receptors 118 may be insulated from the inner cylinder, such as, e.g., comprising an insulation boot. Conductive protrusions 121 may be disposed on the outer cylinder, and may be connected via single wire 120. Force 112 may be applied by the dog's pull, thus extending the inner cylinder and the outer cylinder of the device, which may cause protrusions 119 to physically contact receptors 118, such as, e.g., by sliding into receptors 118. An audible sound may be produced through a speaker system communicatively coupled to controller 117. The sound may be unpleasant to the dog, which may cause it to stop pulling. The cessation of the pulling may cause the inner cylinder and the outer cylinder to contract again through the elastic. Protrusions 119 and receptors 118 may then physically separate, thus breaking the circuit again causing the sound to cease.

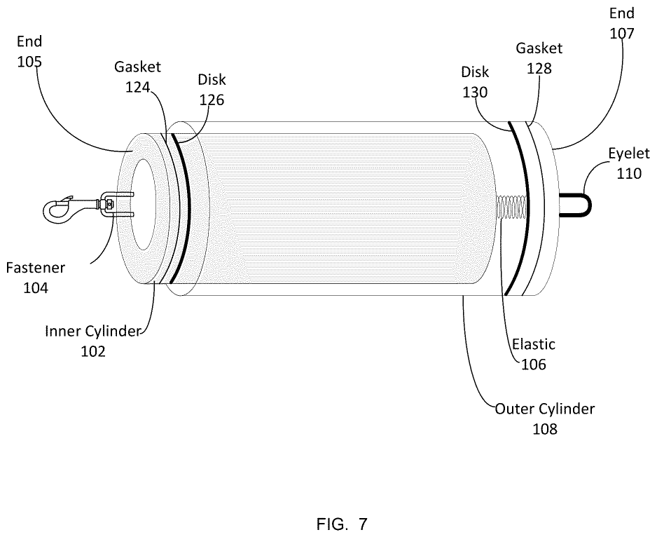

FIG. 7 shows an alternative configuration of the double-cylinder dog training device. Inner cylinder 102 may comprise gasket 124 disposed between disk 126 and end 105 of inner cylinder 102. Gasket 124 may be configured to absorb shock from the movement of inner cylinder 102 within outer cylinder 108, adding structural integrity and durability to the device. Fastener 104 may be physically coupled to disk 126 such that it protrudes through an opening of end 105. Outer cylinder 108 may comprise gasket 128 disposed between disk 130 and end 107 of outer cylinder 108. Gasket 128 may be configured to absorb shock from the movement of inner cylinder 102 within outer cylinder 108, adding structural integrity and durability to the device. Gasket 124 and gasket 128 may be made of any material that dampens kinetic force, such as, e.g., rubber. Eyelet 110 may be physically coupled to disk 126 such that it protrudes through an opening of end 105. Disk 126 and disk 130 may be made from the same or different material as inner cylinder 102 and/or outer cylinder 108, such as, e.g., steel, aluminum, or plastic.

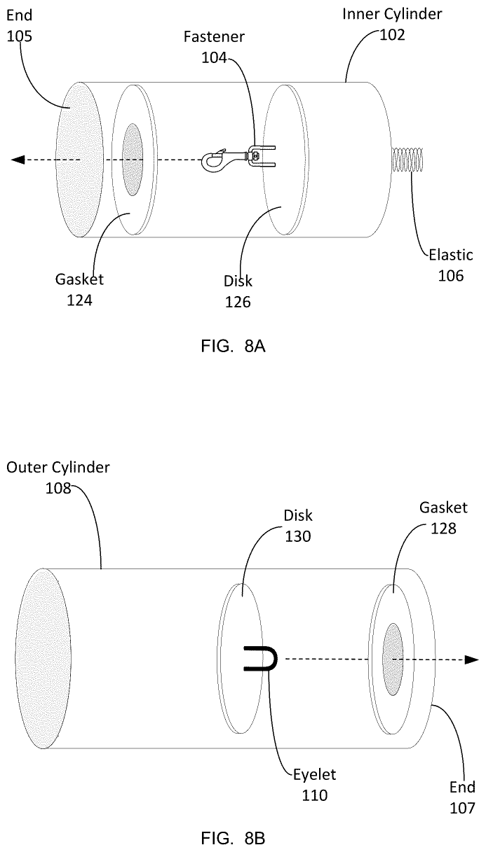

FIG. 8A is a schematic diagram of the inner cylinder of the alternative configuration of FIG. 7. Inner cylinder 102 may comprise gasket 124 disposed between disk 126 and end 105 of inner cylinder 102. Gasket 124 may be configured to absorb shock from the movement of inner cylinder 102 within outer cylinder 108, adding structural integrity and durability to the device. Gasket 124 may be made of any material that dampens kinetic force, such as, e.g., rubber. Fastener 104 may be physically coupled to disk 126 such that it protrudes through an opening of end 105, shown by an arrow drawn in broken line. Disk 126 may be made from the same or different material as inner cylinder 10, such as, e.g., steel, aluminum, or plastic. Elastic 106 may be physically coupled to inner cylinder 102's end farthest from fastener 104. In some cases, elastic 106 may span the length of inner cylinder 102 such that inner cylinder 102 is open on the end opposite of end 105, and is physically coupled to inner cylinder 102 on the opposite face of end 105.

FIG. 8B is a schematic diagram of the outer cylinder of the alternative configuration of FIG. 7. Outer cylinder 108 may comprise gasket 128 disposed between disk 130 and end 107 of outer cylinder 108. Gasket 128 may be configured to absorb shock from the movement of inner cylinder 102 within outer cylinder 108, adding structural integrity and durability to the device. Gasket 128 may be made of any material that dampens kinetic force, such as, e.g., rubber. Eyelet 110 may be physically coupled to disk 130 such that it protrudes through an opening of end 107. Disk 130 may be made from the same or different material as outer cylinder 108 and/or outer cylinder 108, such as, e.g., steel, aluminum, or plastic.

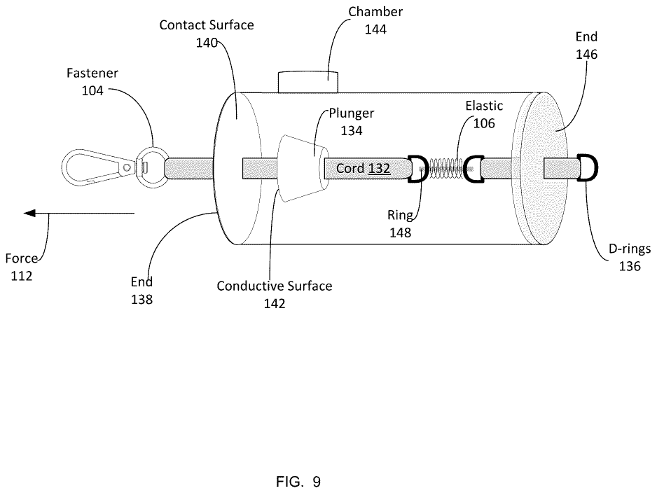

FIG. 9 illustrates a single-cylinder configuration for a dog training device. An assembly of elastic 106, cord 132, plunger 134, and a plurality of D-rings 136 may span the length of the cylinder. A terminal end of cord 132 may be coupled to fastener 104 and end 138 such that when force 112 is applied, e.g., a dog pulling on a leash coupled to fastener 104, elastic 106 expands thereby permitting cord 132 to shift outward through end 138, lengthening its portion outside of the cylinder that is coupled to fastener 104. This in turn moves plunger 134 towards contact surface 140, effectively contacting conductive surface 142 of plunger 134 if enough force 112 is applied. Flat conductive surface 142 may complete a broken circuit of contact surface 140 such that it activates at least one of a battery, speaker, and controller within chamber 144. An audible stimulus may be emitted until the pet stops pulling. Cord 132 may span through, and be fixed in position, e.g., immovable, to end 146. The other terminal end of cord 132 may be coupled with one of the plurality of D-rings 136, in which a leash may be attached. Cord 132 may be made of any material, such as, e.g., nylon. Ring 148 may loop around two of the plurality of D-rings 136 that are coupled to elastic 106, and may provide additional reinforcement to elastic 106 as a stop-limiter by not allowing elastic 106 to be stretched beyond a certain point, such as, e.g., after conductive surface 142 has made physical contact with contact surface 140.

Individual devices may be capable of producing one or more sound. In some cases, a color coding, and an audible sound, are assigned to each device. For example, a red colored device may sound like a C note on a trumpet; a green device may sound like an F on a clarinet; a blue device may sound similar to static noise. For example, a dog owner may have two dogs, and two separately color-coded devices, each assigned to a particular dog. Through conditioning, the dogs may be more receptive to its assigned device, and thus sound.

The device may comprise a secondary, manually operated system of emitting the same auditory stimulus, and may be used to reinforce behavior modification by delivering the same deterrent signal when the dog engages in other undesirable behaviors, such as, e.g., chewing on furniture. By using the same stimulus across contexts, the dog may more quickly associate the signal with a general ‘no’ command, improving training effectiveness.

A number of examples have been described. Nevertheless, it will be understood that various modifications may be made without departing from the spirit and scope of the claimed invention. In addition, the logic flows depicted in the figures do not require the particular order shown, or sequential order, to achieve desirable results. Other steps may be provided, or steps may be eliminated, from the described flows, and other components may be added or removed. Accordingly, other examples are within the scope of the following claims.

What is claimed is:

1. An apparatus, comprising:
a closed cylinder;
an elastic;
a fastener,
wherein the fastener is configured to be removably coupled to a collar;
an eyelet, and
wherein the eyelet is configured to be removably coupled to a leash.

2. The apparatus of claim 1,
wherein the elastic is connected to two D-rings on each end.

3. The apparatus of claim 2,
wherein a first D-ring of the two D-rings is connected a first end of the closed cylinder through a first cord, and
wherein the first end is closed.

4. The apparatus of claim 3, further comprising:
a ring joining the two D-rings, and encapsulating a length of the elastic for limiting an expansion of the elastic.

5. The apparatus of claim 3,
wherein the cord runs through the closed first end and its termination is connected to the eyelet.

6. The apparatus of claim 3,
wherein the cord is fixed in position to the closed first end.

7. The apparatus of claim 3,
wherein a second D-ring of the two D-rings is connected to a second end of the closed cylinder through a second cord, and
wherein the second end is closed.

8. The apparatus of claim 7,
wherein the second cord is not fixed in position to the second end, and
wherein the second cord is slidably connected to the second end.

9. The apparatus of claim 8,
wherein the second cord runs through the second closed end and its termination is connected to the fastener.

10. The apparatus of claim 7,
wherein the second cord comprises a plunger fixed in position between the second end and the second cord.

11. The apparatus of claim 10,
wherein the plunger comprises a first conductive surface, and
wherein the second end comprises a second conductive surface.

12. The apparatus of claim 11,
wherein the first conductive surface and the second conductive surface are configured to make physical contact when a force is applied to the fastener causing the elastic to expand in length.

13. The apparatus of claim 12,
wherein the physical contact completes a broken circuit of the second conductive surface.

14. The apparatus of claim 13,
wherein completion of the broken circuit causes a wave to be emitted from the device.

15. The apparatus of claim 1,
wherein the elastic couples the closed cylinder within an outer cylinder, and
wherein the closed cylinder is configured to slide outwardly within the outer cylinder when a force is applied to the fastener.

16. The apparatus of claim 15,
wherein the fastener is fixed in position to a first end of the closed cylinder, and
wherein the fastener is configured to be removably coupled to a collar.

17. The apparatus of claim 15,
wherein a closed end of the outer cylinder comprises an eyelet fixed to its outer surface and configured to be removably coupled to a leash.

18. The apparatus of claim 15,
wherein the sliding outwardly of the closed cylinder within the outer cylinder causes a rod that is fixed to an inner surface of the outer cylinder to slide along two slots of the closed cylinder,
wherein ends of the rod is configured to mate with receptors of the two slots when the closed cylinder is displaced a predetermined distance outwardly from the outer cylinder, and
wherein a circuit is closed when the ends of the rods are mated with the receptors of the two slots causing a wave to be emitted.

19. The apparatus of claim 15,
wherein the sliding outwardly of the closed cylinder within the outer cylinder causes a pair of protrusions that is fixed to an inner surface of the outer cylinder to slide along two slots of the closed cylinder,
wherein the pair of protrusions are configured to mate with receptors of the two slots when the closed cylinder is displaced a predetermined distance outwardly from the outer cylinder, and
wherein a circuit is closed when the pair of protrusions are mated with the receptors of the two slots causing a wave to be emitted.

20. The apparatus of claim 19,
wherein the elastic spans the length of closed cylinder.
